(19) United States
(12) Patent Application Publication
(10) Pub. No.: US 2008/0090146 A1
(43) Pub. Date: Apr. 17, 2008

(54) Bipolar Battery Electrode Structure and Sealed Bipolar Battery Assembly

(76) Inventor: David Batson, Winchester, MA (US)

Correspondence Address: MCDERMOTT WILL & EMERY LLP, 28 STATE STREET, BOSTON, MA, 02109-1775, US

(21) Appl. No.: 11/871,560

(22) Filed: Oct. 12, 2007

Related U.S. Application Data
(60) Provisional application No. 60/851,839, filed on Oct. 12, 2006.

(51) Int. Cl. H01M 4/00; B23K 1/00; B23K 11/00; B23K 15/00; B23K 20/10; B23K 26/20

(52) U.S. Cl. 429/200; 219/117.1; 219/121.14; 219/121.64; 228/110.1; 228/177; 29/746; 429/188; 429/210

(57) ABSTRACT

The present disclosure describes embodiments of bipolar plate electrode structures for use in an electrochemical battery assembly and a bipolar battery assembly utilizing the bipolar electrode plate structure as a fundamental building block. An exemplary bipolar electrode assembly can have an electrically isolated mechanical supporting plate sandwiched between two electrically conducting electrode substrate plates which are mechanically and electrically connected through holes in the supporting plate. Vapor and liquid tight sealing can be accomplished with an internal sealing ring placed in compression between and thermally bonded to the two conducting electrode substrates. The exposed metallic edges of the electrode supports and substrates can provide improved heat removal from the bipolar battery assembly. Associated construction methods are also described.

### RELATED APPLICATION

This application is based upon and claims priority from U.S. Provisional Application 60/851,839 filed on Oct. 12, 2006, the contents of which are incorporated herein by reference.

### TECHNICAL FIELD

This disclosure relates to electrochemical storage batteries and bipolar battery electrode structures. The disclosure also relates to methods of manufacturing bipolar electrode structures and a bipolar battery assemblies.

### BACKGROUND OF THE DISCLOSURE

The construction of a bipolar battery can dramatically affect the weight, volume and thermal efficiency of the particular battery, and also the application in which it is used. This can be particularly so in battery applications requiring multiple interconnected batteries providing high voltage and high power, such as for electric vehicle or hybrid electric vehicle motive power applications. The bipolar battery structure can affect the weight and electrical resistance of cell to cell interconnections required when utilizing individual battery cells connected in series to develop the high voltages required for many high power applications.

Additionally, the internal structure of a bipolar battery affects the internal electrical resistance and heat generation. For example, the electrical current flow is normal to an electrode stack in bipolar designs whereas in a prismatic or spiral wound (jelly roll) cell designs the current flow is along the length of the electrodes. This difference allows the use of very thin substrates, where as in the latter designs, thicker substrates are advantageous for reducing the cell internal resistance.

A bipolar battery structure building block typically includes a bipolar plate having a negative electrode on one side of a solid, electrically conductive substrate and a positive electrode on the opposite face of the substrate. Such bipolar plates are then typically arranged and stacked with an insulating and typically an electrolyte absorbing, ionic conducting, separator material layer in between successive plates such that each negative electrode of one plate is facing the positive electrode of the next bipolar plate with a separator layer electrically isolating the two electrode faces. This arrangement places successive plates in electrical series.

Batteries utilizing bipolar construction have seen only limited use and these have been mostly applied in reserve type primary batteries for short time duration military and aerospace applications. This has been due primarily to the failure of peripheral seals around the bipolar plates, allowing electrolyte leakage from the cells over time, limiting the life of the battery and in some cases causing cell to cell electrical shorting due to plating of anodic metals across electrolyte bridges from cell to cell. Cell charge control issues, thermal dissipation limitations, differential cell pressures, and excessive manufacturing cost have also contributed to the lack of commercial use of this battery construction technique for secondary or rechargeable battery systems.

Bipolar battery construction using various thermoplastic sealing components has been employed in the past as described by Fredriksson (U.S. Pat. No. 7,097,937) and Hossain (U.S. Pat. No. 5,595,839). This approach, while satisfactory for relatively short lived primary batteries and reserve activated batteries, does not provide the long term sealing reliability required for rechargeable or long lived primary batteries. Additionally, this seal construction creates a thermal insulating layer around the bipolar stack arrangement, reducing radial heat transfer, increasing the operating temperature and thus limiting the power capability of the battery.

U.S. Pat. No. 5,578,394 to Oweis et al. (“Oweis”), describes a seal assembly for high temperature bipolar Li alloy metal Sulfide battery which utilizes metallic ring with ‘C’ shaped cross section which is bonded on end to a ceramic sealing component and welded around the periphery on the opposing end to a similar ceramic sealing component having a bonded metal weld ring, thereby forming a sealed enclosure around the bipolar electrode pair. The manufacturing process to fabricate the described ‘C’ shaped housing component is complex and costly, involving either cutting and forming seamless extruded tube or an extra welding operation to form the cylindrical ‘C’ shaped component. U.S. Pat. No. 5,162,172 to Kaun describes a high temperature bipolar Li alloy metal Sulfide battery in which ceramic sealing components are bonded to an electrode substrate component utilizing a ceramic sulfide bonding material. Separate metallic (steel) flanges are additionally bonded to the ceramic sealing components. The resulting electrode assembly is then stacked and the exposed steel flanges are welded, forming a sealed bipolar battery structure.

The electrode substrate of Oweis is further formed with a cylindrical depression around the plate, allowing the substrate to move vertically to account for changes in electrode thickness changes during charge and discharge. The electrode structure and seal structure described is complex in shape and assembly operation, having features not required for ambient temperature battery operations. The bipolar electrode described includes at least four components of relative complex cross section to form the described battery, excluding active materials and separators.

U.S. Pat. No. 5,254,415 to Williams et al. describes a stacked cell bipolar battery with thermal sprayed container and cell seals. While advantageous for a high temperature battery (with a LiAl alloy/FeS2), the contemplated thermal spraying of 20 mil thick ceramic as well as thermal spraying of a 50 mil thick layer of 410 stainless steel would cause significant thermal damage to the electrodes and separators employed in most ambient temperature batteries today. Also the cost of the described battery manufacturing technique would prevent its use outside of the less cost sensitive aerospace and military application areas.

### SUMMARY

Embodiments of a bipolar electrode structure, assembly method, and resulting bipolar battery assembly as described herein, address and correct the technical issues associated with the previous battery technology. The bipolar battery structures according to the present disclosure can enable lower weight and higher power capable batteries with reduced life cycle cost for use in such devices as, for example. hybrid electric vehicles as well as improving the power and range of full electric vehicles.

Other features and advantages of the present disclosure will be understood upon reading and understanding the detailed description of exemplary embodiments, described herein, in conjunction with reference to the drawings.

### BRIEF DESCRIPTION OF THE DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 is a perspective view of one embodiment of a bipolar battery assembled in accordance with this disclosure;

FIGS. 2, 2A, and 2B respectively show a top view, side view, and sectional view of one bipolar battery secured in the assembly of FIG. 1;

FIG. 3 is detailed cross-sectional view, partially cut away, of one bipolar battery secured in the assembly of FIG. 1;

FIG. 4 is an exploded view of one bipolar battery and the portions of the assembly for securing the battery as a part of the assembly of FIG. 1; and

FIGS. 5 shows perspective, top, side, and section views of the battery mechanical support plate of the assembly shown in FIG. 1; FIG. 5A shows an enlarged detail of FIG. 5.

While certain embodiments depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION

Aspects and embodiments of the present disclosure are directed to bipolar electrode structures, related assembly methods, and resulting bipolar battery assemblies.

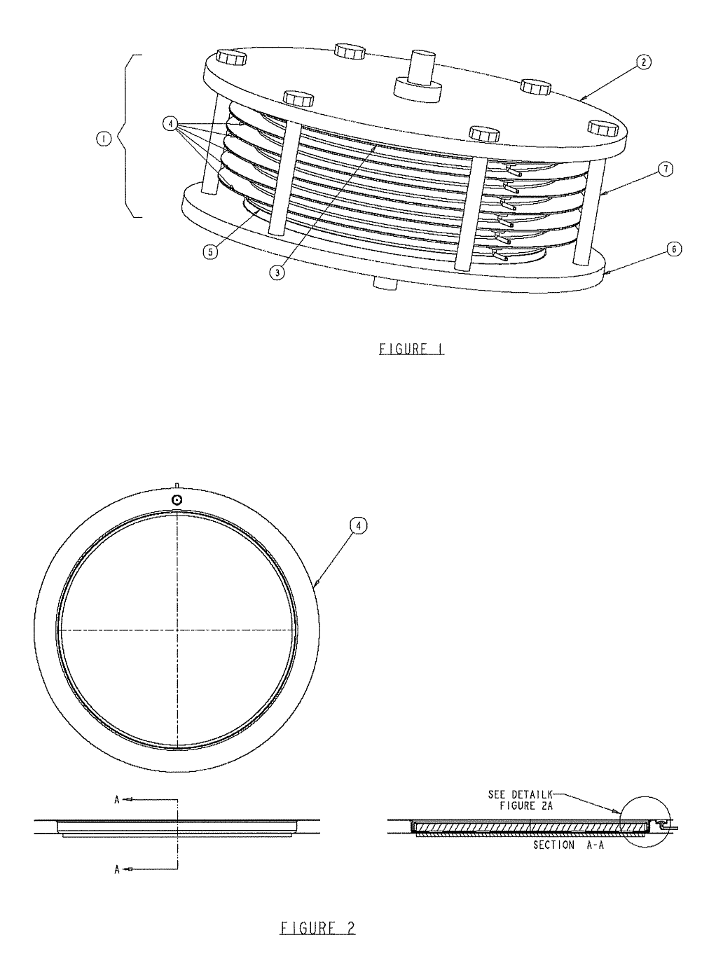

FIG. 1 depicts an exemplary embodiment 100 of a Bipolar Battery Assembly 1 according to the present disclosure. As shown, the Bipolar Battery Assembly 1 consists of a mechanical support end plate 2, a first polarity half electrode 3, at least one or more bipolar electrode assemblies 4 connected electrically in series, a second polarity half electrode 5, a second mechanical support end plate 6, and three or more mechanical fasteners 7, providing axial compression force on the battery assembly 1.

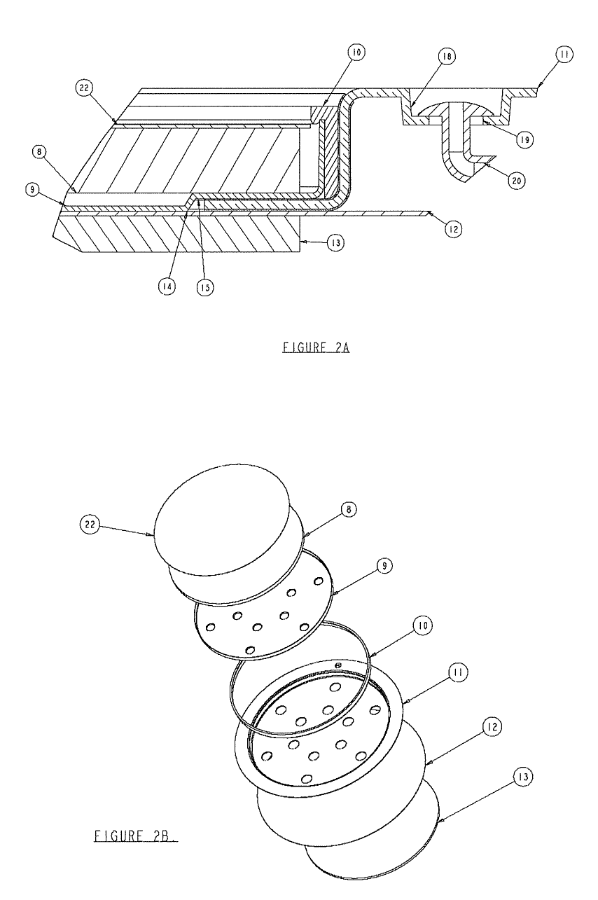

Referring to FIG. 2, which is a view of the bipolar electrode assembly 4, the bipolar electrode assembly 4 cross section is shown in detail in FIG. 2A and an exploded view in FIG. 2B. The bipolar electrode assembly 4 consists of a first electrode 8 made of an electrochemically active material, a first electrode substrate 9, a polymeric sealing ring 10, a mechanical support plate 11, a second electrode substrate 12, and a second electrode 13 made of a second type electrochemically active material.

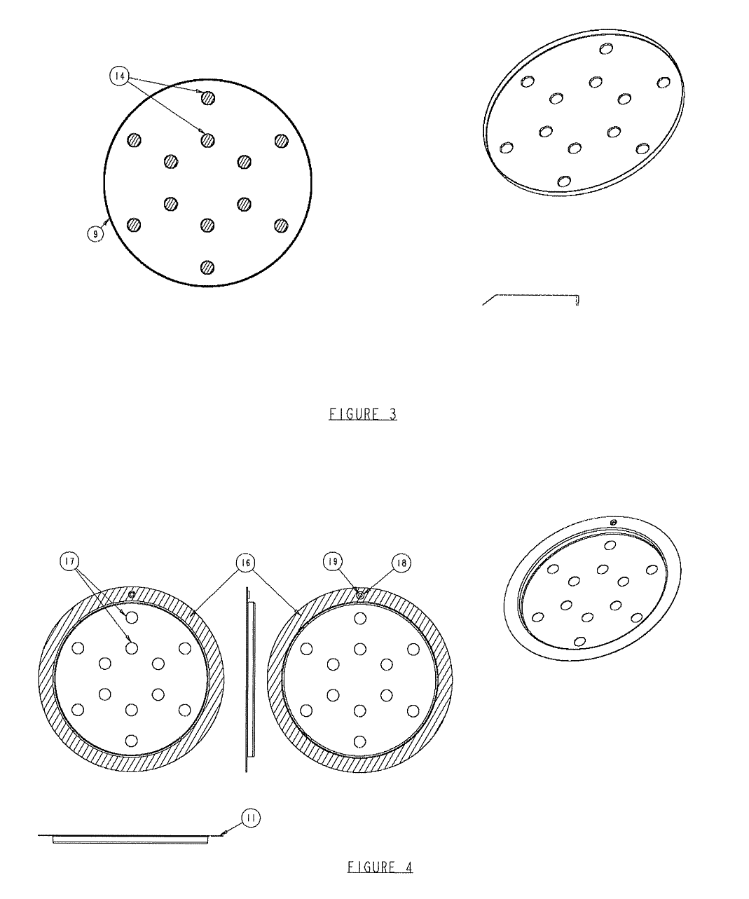

Depicted in FIG. 3, the first electrode substrate 9 can be configured as a metallic cup shaped plate, having a substantially flat surface and a vertical wall. The vertical wall can have an outward draft angle of 1 to 10 degrees. The flat portion of the substrate has at least one or more circular protrusions 14 formed into it, creating circular areas offset from the flat surface. The outer surface of the substrate is coated with a polymeric electrically insulating layer 15, which can be about 0.0002″ to about 0.006″ thick (e.g., 0.2 mils to 6 mils) in exemplary embodiments. The thermoplastic layer material can be applied by thermal spray coating. The flat-faced offset areas 14 are preferably kept free of polymeric coating material.

The sealing ring 10 is a thermoplastic component manufactured by injection molding or casting, which has a substantially ‘L’ shaped cross section. The bottom leg of the ‘L’ has a protrusion of circular cross section, which provides a locking snap feature during assembly of the bipolar electrode assembly 4.

In exemplary embodiments, a second electrode substrate 12 can have a flat metallic, electrically conductive plate, having one side spray coated with a thermoplastic layer of suitable thickness, e.g., 0.0002″ to 0.006″ thick. At least one or more circular areas 21 can be excluded from the spray coating by masking or removal of the coating in diameter and pattern to match the stamped offset areas 14 of the first electrode substrate 9 and which match the pattern of the punched through holes of the support plate 11.

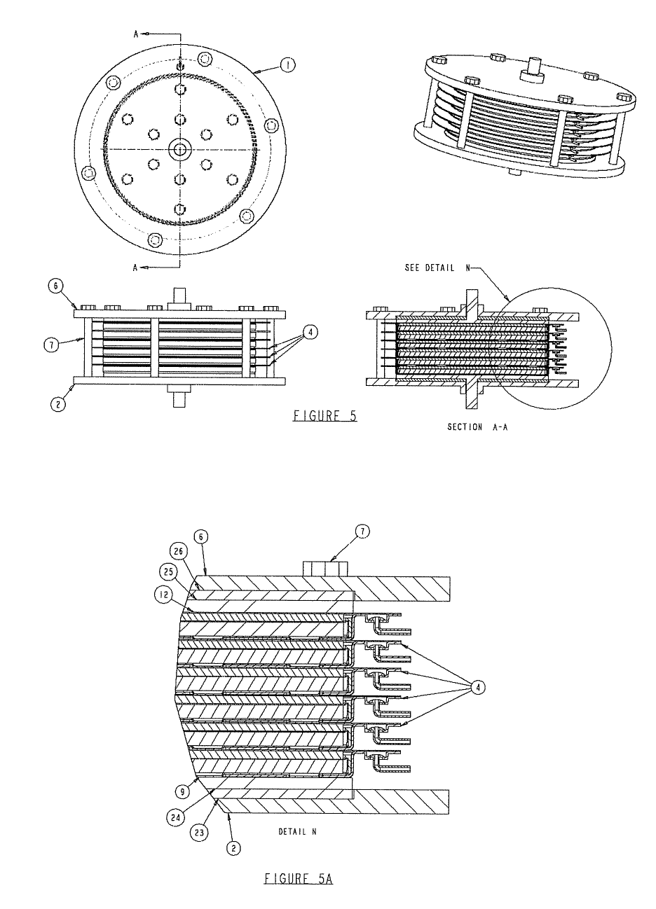

Referring to FIG. 4, the mechanical support plate 11 can be configured as a metallic cup shaped plate, having a flat-flanged area 16, extending beyond the diameter of the vertical wall of the support plate. The flat surface of the support plate can have at least one or more circular holes 17 punched through it, whose pattern and location match those of the stamped offset areas of the first electrode substrate 9, but whose diameters are larger than the diameter of the stamped offsets 14 formed in the first electrode substrate 9. The support plate 11 can be additionally spray coated with a thermoplastic layer, e.g., one that is about 0.0002″ to about 0.006″ thick on all surfaces, excluding the flat-flanged area 16. Additionally, the flat flange area 16 of the support plate can be configured as a circular stamped offset area 18 and a through hole 19 formed on the face of the stamped circular offset area 18 to accept a fill tube or pressure relief vent 20.

### An Exemplary Embodiment of the Bipolar Plate Structure Assembly Steps

The second electrode substrate 12 can be placed and held flat with the previously spray-coated surface facing upward. The support plate 11, previously coated, with fill tube/vent 20 previously installed, can be placed on top of the second electrode substrate 12 with the circular holes 17 of the support plate 11 aligned with the circular coating free areas 21 of the second electrode substrate 12. Next the sealing ring 10 can be pressed into place along the inside surface of the support plate 11 vertical wall. The first electrode substrate 9, having aligned the stamped offsets 14 with the through holes 17 of the support plate 11, can then be pressed into the inside of the sealing ring 10 until the bottom surface of the first electrode substrate 9 makes contact with the surface of the support plate 11.

The drafted vertical wall of the first electrode substrate 9 will deform the leg of the “L” shaped sealing ring 10, causing the top edge of the first electrode substrate 9 to snap into contact with the inside vertical wall of the seal ring 10. In the assembled position the draft angle of the drafted wall of the first electrode substrate 9 is substantially reduced, creating a permanent outward compressive force on the sealing ring 10.

Welding or brazing the first electrode substrate 9 and the second electrode substrate 12 in the uncoated circular contacting areas electrically and mechanically connects the first and second electrode substrates. The welding can be accomplished by suitable techniques, e.g., resistance welding, ultrasonic welding, laser welding, electron beam welding or brazing.

The resulting assembly can then be heated to near the thermoplastic melting point, thermally bonding the contacting coated surfaces of the first electrode substrate 9, support plate 11, second electrode substrate 12 and the sealing ring 10, creating a liquid tight seal between the inside surface of the first electrode substrate 9 and the outside of the bipolar plate assembly 4, while maintaining electrical isolation between the two electrode substrates and the support plate 11.

This design is applicable to many different primary and secondary electrochemical systems currently being employed, such as Lithium primary batteries, Nickel-Metal Hydride and Lithium Ion rechargeable batteries for example. The selection of materials will be determined by performance, cost and chemical compatibility considerations for any particular battery chemistry system utilized.

For a Nickel Metal Hydride bipolar battery with aqueous KOH electrolyte, the first and second electrode substrates are selected from Nickel, Nickel-plated steel or stainless steel. The polymer coating and sealing ring are selected from Nylon or Polypropylene. The first electrode 8 can be a plastic bonded Nickel Oxide powder, pasted onto metallic foam, expanded metal grid or directly onto the first electrode substrate 9. The second electrode 13 can be a Misch-metal hydrogen absorbing alloy powder pasted onto metallic foam, expanded metal grid or directly onto the second electrode substrate 12. A separator 22 of non-woven or micro-porous polyolefin sheet can be present to provide electrical and mechanical isolation between the first and second electrodes while allowing ionic current to flow during battery charge and discharge.

In a Lithium Ion rechargeable bipolar battery embodiment, utilizing an organic solvent based electrolyte, the first electrode 8 is graphite and carbon powder with plastic binder pasted onto an expanded metal grid or directly onto the first electrode substrate 9. The first electrode substrate 9 can be Copper. The second electrode 13 would be a mixture of lithiated Cobalt Oxide, Carbon and plastic binder or a mixture of lithiated Iron Phosphate, carbon and plastic binder, pasted onto an expanded metallic grid or directly onto the second electrode substrate 12.

The second electrode substrate 12 can be, in exemplary embodiments, made of Aluminum or an Aluminum alloy. The support plate 11 is also Aluminum or Aluminum alloy, allowing effective edge welding of the first electrode substrate 9 and support plate 11. The separator 22 is a micro-porous polyethylene. The polymer coatings and sealing ring 10 are a thermoplastic compatible with the electrolyte solution such as Tefzel (ETFE), polyamide or polyethylene.

The detailed description herein provided describes a cylindrical bipolar electrode assembly 4 and a bipolar battery assembly 1. This design approach is also applicable to bipolar batteries of other shapes, such as rectangular, square or ‘D’ shape. The cylindrical shape was chosen for convenience of communication of the design approach and key features and does not imply any limitation of the application of this invention to other geometrical shapes.

### An Exemplary Embodiment of a Bipolar Battery Assembly

The bipolar battery assembly 1, utilizes the previously described bipolar electrode assembly 4 as a fundamental building block. FIGS. 5 and 5A depict the bipolar battery assembly 1, having a bottom external stack supporting end plate 2 made of non-conducting plastic, an elastic foam spacer 23, a first polarity current collector 24, previously welded or brazed to the first electrode substrate 9 of a partially assembled bipolar electrode assembly 4, wherein the first polarity current collector 24 replaces the second electrode substrate 12, at least one or more bipolar electrode assemblies 4 stacked vertically in electrical series, a separator layer, a second polarity electrode, a second polarity current collector 25, previously welded or brazed to a second electrode substrate 12, a second elastic foam spacer 26 and the top supporting non-conductive end support plate[6].

After vertically stacking and aligning all the components, the entire assembly can be compressed and held to the final required assembly height using a hydraulic press or similar means. The contacting edges of the second electrode substrates 12 and the mechanical support plates 11 are then welded continuously around the perimeter, creating a hermetic seal between the support plates 11 and the second electrode substrates 12. Suitable techniques such as laser welding, electron beam welding, or tungsten-inert-gas (TIG) welding, etc., can accomplish the edge welding. The appropriate process can depend upon specific materials utilized for these two components. After welding, a suitable number of mechanical fasteners, e.g., three or more mechanical fasteners, 7 can be installed through the two external end support plates 2,6, so as to maintain the required stack height or amount of stack compression desired.

The top and bottom external supporting end plates 2,6 are made of molded high strength plastic, such as glass filled Valox (PBT) or similar engineering resin. The external support plates further may have stiffening ribs (not shown), running from the outside edge to the inside edge to provide high mechanical resistance to bending from internal pressure of the battery assembly. The outer periphery of the support plates 2,6 extend beyond the outer periphery of the bipolar electrode assemblies 4 and provide multiple through holes for the fasteners 7 which extend from the top support plate 2 to the bottom support 6, allowing compressive force to be applied to the entire assembly by controlled torque on the fasteners 7. Alternatively, the supporting end plates could be made of a lightweight metal, such as machined or cast Aluminum or Titanium alloy.

The foam spacers 23,26 are made of closed cell elastic foam, such as high-density polyethylene foam or alternatively, a low or medium hardness (durometer value) rubber. This compressible and elastic layer accommodates growth and shrinkage of the active electrodes during charge and discharge of the bipolar battery, while maintaining required axial compression on the stack. The thickness and durometer of the foam layers are selected to accommodate the expected electrode displacement and provide required compression force for a specific battery stack design.

The first polarity current collector 24 is a metallic electrically conductive flat plate with a conductive connector attached at its central portion. The example shown depicts a threaded circular connector welded to the center of the current collector. Alternative connectors, such as flat ribbon stock or welded circular wire could also be employed. The current collector plate 24 is of sufficient thickness and conductivity to provide low electrical resistance to current flow in the radial direction. The first polarity current collector 24 is fused to the first electrode substrate 9 of a partially assembled bipolar electrode assembly 4 by welding, brazing or soldering, prior to assembly of the bipolar battery stack, the first polarity current collector taking the place of the second electrode substrate 12.

The second polarity current collector 25 is of substantially identical construction as the first polarity current collector 24, though it may be desirable to make the electrical connector of different dimensions to prevent incorrect polarity connection during installation in the application. The second polarity current collector 25 is fused to a second electrode substrate 12 by welding, brazing or soldering prior to completing the assembly of the bipolar electrode assembly 4 to which is attached.

The assembly of the bipolar stack is completed by welding the periphery of the second polarity current collector 25 to the support plate 11 of the adjacent bipolar plate assembly 4. The bipolar battery can them be activated by vacuum filling each of the bipolar cells via the fill port 20 and then plugging the fill ports to prevent leakage.

An electronics module, not shown, may be attached to the exposed edges of the bipolar plates, via welding or soldering metal tabs, allowing monitoring of individual cell voltages and other electronic control functions such as charge balancing and or safety shut off to prevent over-charge or over-discharge of individual cells of the bipolar battery stack.

Further, a common pressure manifold connected to individual cells via the venting/fill tube 20, may be utilized to eliminate large pressure differences between cells of the battery stack, preventing mechanical damage to adjacent cells in the event of high pressure in any one cell of the bipolar battery assembly.

### An Exemplary Embodiment of a Battery/Housing Assembly

Lastly, the assembled bipolar battery 1 may be inserted and mounted within a battery housing 27. The cover plates 28,29 of the battery housing 26 having central holes 30, allow the current connectors of the bipolar battery stack to protrude through. The inside dimension of the battery housing 27 is closely matched to the outside dimension of the bipolar battery stack end plates 2,6, such that the stack end plates provide lateral support of the bipolar battery 1 within the housing 27 while maintaining electrical isolation between housing 27 and the bipolar battery assembly 1.

The battery housing 27 provides mechanical protection to the bipolar battery assembly 1 as well as providing mounting features to allow integration with the application system. For very high power batteries and battery chemistry systems which may generate large amounts of heat during high rate charging, such as Nickel-Metal Hydride or Nickel-Iron, an active cooling system may be required. By mounting the battery stack in a housing 27 that has an airflow manifold 31 and providing forced air flow into and out of the battery housing 27, very effective active cooling of the bipolar battery assembly 1 is accomplished. Effective cooling is provided for by the exposed edges of the bipolar electrode assemblies 4. These exposed edges act as heat exchange fins, greatly improving heat removal from the bipolar battery 1 using forced or natural convection.

While certain embodiments have been described herein, it will be understood by one skilled in the art that the methods, systems, and apparatus of the present disclosure may be embodied in other specific forms without departing from the spirit thereof.

Accordingly, the embodiments described herein, and as claimed in the attached claims, are to be considered in all respects as illustrative of the present disclosure and not restrictive.

What is claimed is:

1. A bipolar electrode structure comprising:
one or more bipolar electrode assemblies connected in series, each bipolar electrode assembly including a first electrode made of an electrochemically active material, a first electrode substrate, a polymeric sealing ring, a mechanical support plate, a second electrode substrate, a second electrode made of a second type electrochemically active material, and a fill/vent tube configured and arranged for fluid flow;
first and second polarity half electrodes, connected in series with the one or more bipolar electrode assemblies; and
first and second support plates configured and arranged to hold the one or more bipolar electrode assemblies and the first and second polarity half electrodes.

2. The bipolar electrode structure of claim 1, further comprising one or more fasteners configured and arranged to provide suitable compression force to the first and second plates.

3. The bipolar electrode structure of claim 1, wherein a first electrode substrate is configured as a metallic cup shaped plate, having a substantially flat surface with one or more circular stamped offset areas and a vertical wall.

4. The bipolar electrode structure of claim 3, wherein the vertical wall can have an outward draft angle of about 1 degree to about 10 degrees.

5. The bipolar electrode structure of claim 3, further comprising a polymeric sealing ring configured and arranged to form a liquid tight seal between the displaced drafted vertical wall of the first electrode substrate and the vertical wall of the support plate.

6. The bipolar electrode structure of claim 1, wherein the mechanical support plate is configured as a metallic cup shaped plate, having a flat-flanged area, extending beyond the diameter of the vertical wall of the support plate.

7. The bipolar electrode structure of claim 6, wherein a flat surface of the mechanical support plate includes least one or more circular holes configured in a pattern and location to match those of stamped offset areas of the first electrode substrate.

8. The bipolar electrode structure of claim 1, wherein the mechanical support plate comprises a thermoplastic layer.

9. The bipolar electrode structure of claim 8, wherein the thermoplastic layer is about 0.0002″ to about 0.006″ thick.

10. The bipolar electrode structure of claim 1, wherein the mechanical support plate includes a flat flange configured as a circular stamped offset area with a through hole on the face of the stamped circular offset area configured and arranged to accept a fill/vent tube.

11. The bipolar electrode assembly of claim 1, wherein the second electrode substrate is a metallic flat plate, having outer dimensions substantially equal to those of the support plate.

12. The second electrode of claim 11, where in the second electrode substrate comprises a thermoplastic layer on one surface, having circular uncoated areas equal in pattern and dimension to the stamped offset areas of the first electrode substrate.

13. An assembly method comprising:
providing one or more bipolar electrode assemblies connected in series, each bipolar electrode assembly including a first electrode made of an electrochemically active material, a first electrode substrate, a polymeric sealing ring, a mechanical support plate, a second electrode substrate, a second electrode made of a second type electrochemically active material, and a fill/vent tube configured and arranged for fluid flow;
providing first and second polarity half electrodes, connected in series with the one or more bipolar electrode assemblies; and
providing first and second support plates configured and arranged to hold the one or more bipolar electrode assemblies and the first and second polarity half electrodes;
placing a support plate on top of a second electrode substrate with the circular holes of the support plate aligned with circular coating free areas of the electrode substrate; and
forming a bipolar plate assembly.

14. The assembly method of claim 13, further comprising pressing a sealing ring into place along a surface of the support plate vertical wall.

15. The assembly method of claim 14, further comprising pressing an electrode substrate into the inside of the sealing ring, wherein a surface of the electrode substrate makes contact with the coated surface of the support plate.

16. The assembly method of claim 15, further comprising aligning stamped offsets of the electrode substrate with the through holes of the support plate.

17. The assembly method of claim 16, further comprising welding or brazing a first electrode substrate and a second electrode substrate in uncoated circular contacting areas electrically, wherein the first and second electrode substrates are mechanically connected.

18. The assembly method of claim 17, comprising resistance welding, ultrasonic welding, laser welding, electron beam welding, or brazing.

19. The assembly method of claim 18, further comprising heating the assembly and thermally bonding the contacting coated surfaces of the first electrode substrate, support plate, second electrode substrate and the sealing ring.

20. The assembly method of claim 19, further comprising creating a liquid tight seal between the inside surface of the first electrode substrate and the outside of the bipolar plate assembly and maintaining electrical isolation between the two electrode substrates and the support plate.

21. 1. A bipolar battery comprising:
one or more bipolar electrode assemblies connected in series, each bipolar electrode assembly including a first electrode made of an electrochemically active material, a first electrode substrate, a polymeric sealing ring, a mechanical support plate, a second electrode substrate, a second electrode made of a second type electrochemically active material, and a fill/vent tube configured and arranged for fluid flow;
first and second polarity half electrodes, connected in series with the one or more bipolar electrode assemblies;
first and second support plates configured and arranged to hold the one or more bipolar electrode assemblies and the first and second polarity half electrodes;
and an electrolyte.

22. The bipolar batter of claim 21, wherein the electrolyte comprises an organic solvent based electrolyte.

23. The bipolar batter of claim 21, wherein the electrolyte comprises Tefzel (ETFE), polyamide or polyethylene.
